(19) United States
(12) Patent Application Publication
(10) Pub. No.: US 2021/0358033 A1
(43) Pub. Date: Nov. 18, 2021

(54) APPLY AND BUY WITH A CO-BRANDED VIRTUAL CARD

(71) Applicant: Comenity LLC, Columbus, OH (US)

(72) Inventors: Randy WEST, Pickerington, OH (US); Mary J. FEYH, Pickerington, OH (US); James WALZ, Blacklick, OH (US)

(73) Assignee: Comenity LLC, Columbus, OH (US)

(21) Appl. No.: 17/385,838

(22) Filed: Jul. 26, 2021

Related U.S. Application Data
(63) Continuation of application No. 14/626,773, filed on Feb. 19, 2015, now abandoned.
(60) Provisional application No. 61/954,461, filed on Mar. 17, 2014.

(51) Int. Cl. G06Q 40/02; G06Q 30/02; G06Q 20/40; G06Q 20/34

(52) U.S. Cl. CPC G06Q 40/025; G06Q 30/0269; G06Q 20/351; G06Q 20/405; G06Q 20/409; G06Q 30/0226

(57) ABSTRACT

A method for applying and buying with a co-branded virtual card is disclosed. The method includes receiving a customer application for a co-branded credit card at a time of purchase, performing a customer qualification for the co-branded credit card at the time of purchase, providing access to a virtual co-branded card for a qualified customer, the virtual co-branded card having a valid credit card number, a valid credit card expiration date and a valid credit card security code and authorizing the use of the virtual co-branded card to buy goods at the time of qualification.

### CROSS-REFERENCE TO RELATED APPLICATIONS

This application is a continuation and claims priority to and the benefit of co-pending U.S. patent application Ser. No. 14/626,773, filed on Feb. 19, 2015, entitled “APPLY AND BUY WITH A CO-BRANDED VIRTUAL CARD” by Randy West et al, having Attorney Docket No. ADS-022, and assigned to the assignee of the present application, hereby incorporated by reference in its entirety.

U.S. patent application Ser. No. 14/626,773 claims priority to and benefit of then co-pending U.S. Patent Application No. 61/954,461, filed on Mar. 17, 2014 entitled “APPLY AND BUY WITH A CO-BRANDED VIRTUAL CARD” by Randy West et al., having Attorney Docket No. ADS-022.PRO, and assigned to the assignee of the present application.

### BACKGROUND

Company specific, brand specific or even store specific credit cards provide significant value to both consumer and provider. By issuing a store specific credit card, the provider is able to tailor rewards offers, provide loyalty discounts and maintain consumer brand loyalty. Similarly, the consumer receives the perks from the reward offers, the loyalty discounts and often provides good word provider recommendations via word of mouth, social networks, internet rating sites, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of an example computer system with which or upon which various embodiments may be implemented.

FIG. 2 is a block diagram of an apply and buy co-branded virtual card system, in accordance with an embodiment.

FIG. 3 is a block diagram of a credit-based payment processor using a co-branded virtual card system, in accordance with an embodiment.

FIG. 4 depicts a flow diagram for a method for applying and buying with a co-branded virtual card, in accordance with an embodiment.

FIG. 5 depicts a flow diagram for a method for applying and buying with a co-branded virtual card, in accordance with an embodiment.

FIG. 6 depicts a flow diagram for a method for applying and buying with a co-branded virtual card, in accordance with an embodiment.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. In some embodiments, all or portions of the electronic computing devices, units, and components described herein are implemented in hardware, a combination of hardware and firmware, a combination of hardware and computer-executable instructions, or the like. In one embodiment, the computer-executable instructions are stored in a non-transitory computer-readable storage medium. Furthermore, in the following description, numerous specific details are set forth in order to provide a thorough understanding of the subject matter. However, some embodiments may be practiced without these specific details. In other instances, well-known methods, procedures, objects, and circuits have not been described in detail as not to unnecessarily obscure aspects of the subject matter.

### Notation and Nomenclature

Unless specifically stated otherwise as apparent from the following discussions, it is appreciated that throughout the present Description of Embodiments, discussions utilizing terms such as “selecting”, “outputting”, “allowing,” “limiting,” “issuing,” preventing,” “inputting”, “providing”, “receiving”, “utilizing”, “obtaining”, “performing”, “accessing”, “authorizing” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Example Computer System

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

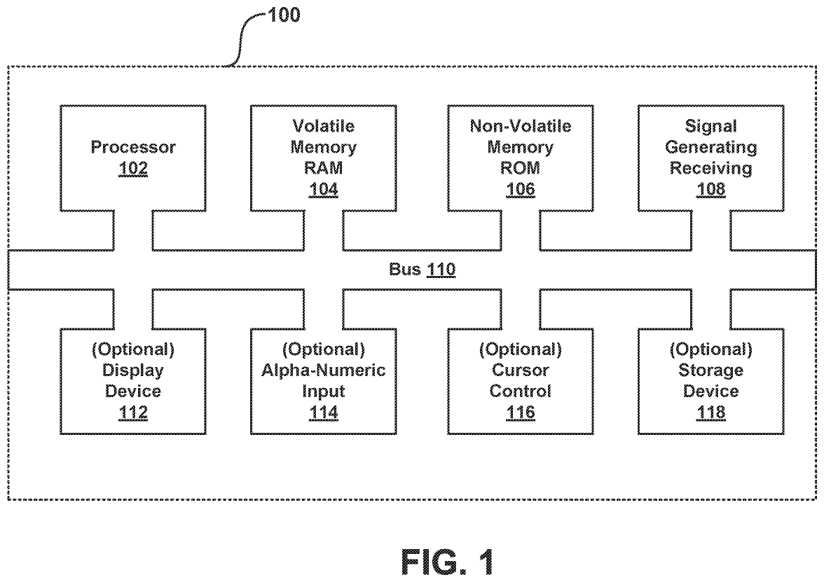

With reference now to FIG. 1, portions of the technology for providing a communication composed of computer-readable and computer-executable instructions that reside, for example, in non-transitory computer-usable storage media of a computer system. That is, FIG. 1 illustrates one example of a type of computer that can be used to implement embodiments of the present technology. FIG. 1 represents a system or components that may be used in conjunction with aspects of the present technology. In one embodiment, some or all of the components described herein may be combined with some or all of the components of FIG. 1 to practice the present technology.

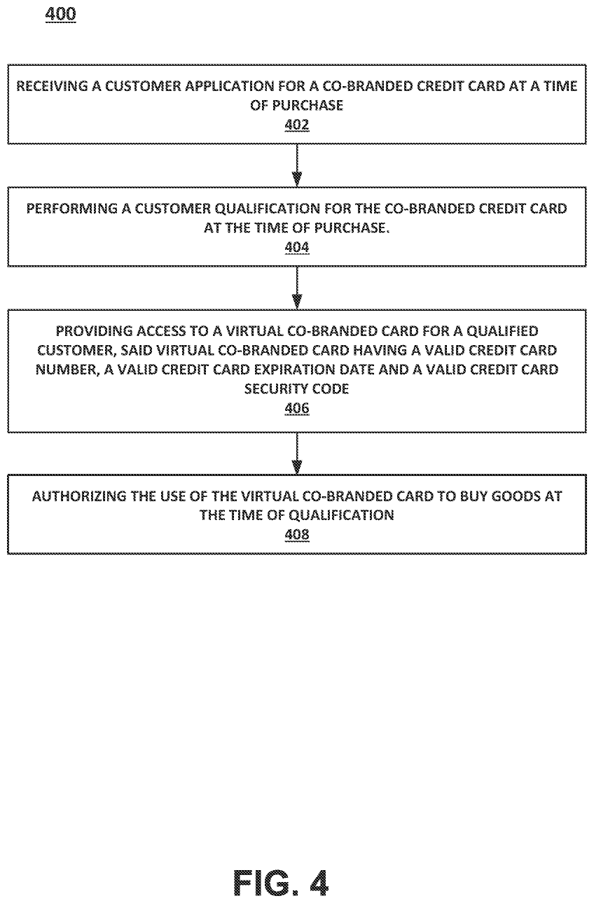

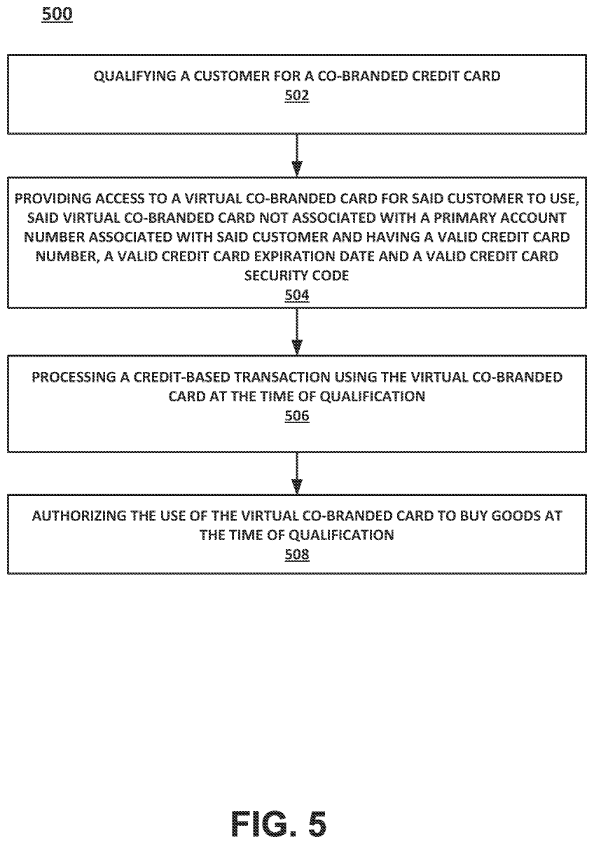

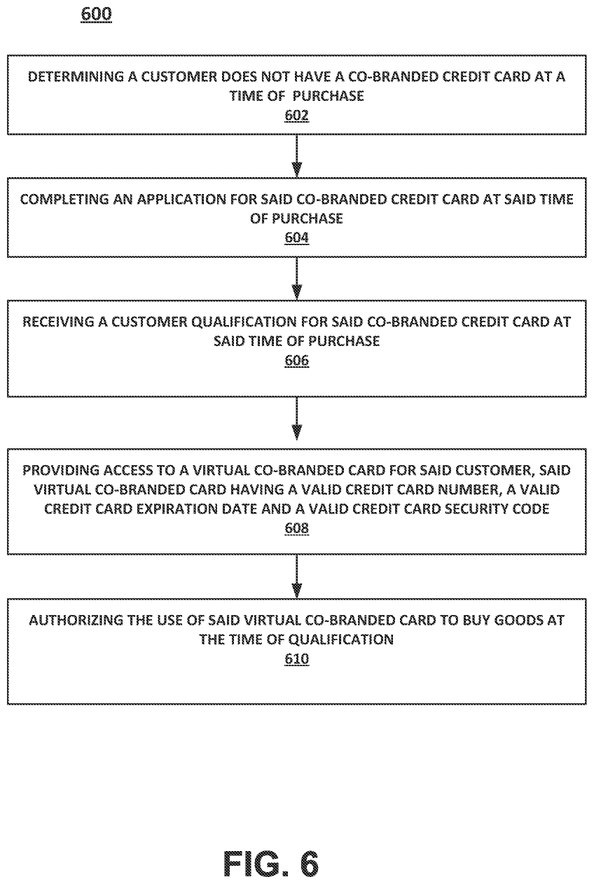

FIG. 1 shows a block diagram of an embodiment of an example computer system 100 used in accordance with various embodiments. It should be appreciated that computer system 100 is not strictly limited to be a computer system. As such, computer system 100 of the present embodiment may be well suited to be any type of computer device (e.g., server computer, portable computer device, desktop computer, mobile phone, pager, personal digital assistant, etc.). Within the present discussions, certain processes and steps are discussed that are realized, in one embodiment, as a series of instructions (e.g., software program) that reside within computer readable memory units and executed by a processor(s) of computer system 100. When executed, the instructions cause computer system 100 to perform specific actions and exhibit specific behavior that may be described in detail herein. For example, computer 100 may be used to implement aspects of methods described herein, such as the method illustrated by flow diagram 400 of FIG. 4 and/or the method illustrated by flow diagrams 500 and 600 of FIGS. 5 and 6, respectively.

Computer system 100 of FIG. 1 comprises an address/data bus 110 for communicating information, one or more central processors 102 coupled with bus 110 for processing information and instructions. Central processor unit(s) 102 may be a microprocessor or any other type of processor. The computer system 100 also includes data storage features such as a computer usable volatile memory unit 104 (e.g., random access memory, static RAM, dynamic RAM, etc.) coupled with bus 110 for storing information and instructions for central processor(s) 102, a computer usable non-volatile memory unit 106 (e.g., read only memory, programmable ROM, flash memory, EPROM, EEPROM, etc.) coupled with bus 110 for storing static information and instructions for processor(s) 102. Computer system 100 also includes one or more signal generating and receiving devices 108 coupled with bus 110 for enabling computer system 100 to interface with other electronic devices and computer systems. The communication interface(s) 108 of the present embodiment may include wired and/or wireless communication technology.

Optionally, computer system 100 may include an alphanumeric input device 114 including alphanumeric and function keys coupled to the bus 110 for communicating information and command selections to the central processor(s) 102. The computer system 100 can include an optional cursor control or cursor directing device 116 coupled to the bus 110 for communicating user input information and command selections to the central processor(s) 102. The cursor-directing device 116 may be implemented using a number of well-known devices such as a mouse, a track-ball, a track-pad, an optical tracking device, and a touch screen, among others. Alternatively, it may be appreciated that a cursor may be directed and/or activated via input from the alphanumeric input device 114 using special keys and key sequence commands. The present embodiment is also well suited to directing a cursor by other means such as, for example, voice commands.

The computer system 100 of FIG. 1 may also include one or more optional computer usable data storage devices 118 such as a magnetic or optical disk and disk drive (e.g., hard drive or floppy diskette) coupled with bus 110 for storing information and instructions. An optional display device 112 may be coupled to bus 110 of computer system 100 for displaying video and/or graphics. It should be appreciated that optional display device 112 may be a cathode ray tube (CRT), flat panel liquid crystal display (LCD), field emission display (FED), plasma display or any other display device suitable for displaying video and/or graphic images and alphanumeric characters recognizable to a user.

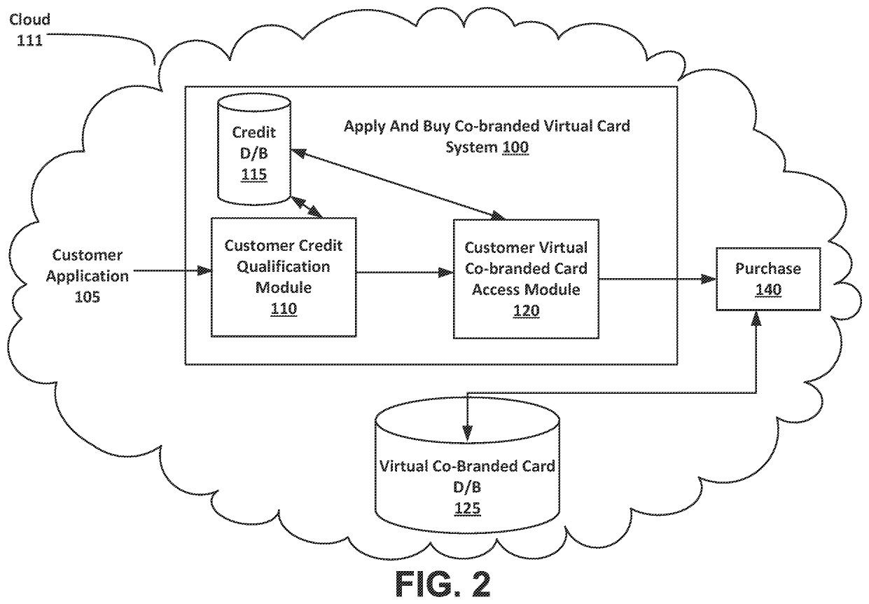

FIG. 2 is a block diagram of an apply and buy co-branded virtual card system 100 shown in accordance with an embodiment. In general, a private label card is a card that can be used for purchases only at the store on the label. In contrast, a co-branded card refers to a card that has a store on the label as well as an underlying credit card network with an accompanying logo. As such, a co-branded card may be used for purchases at the store on the label as well as at other stores that accept that credit card network's credit cards. A virtual co-branded card refers to a temporary card number that can be issued to a customer while the customer waits to receive an actual credit card with an associated credit card number from the credit provider. The virtual co-branded credit card has a valid temporary account number, a valid temporary expiration date and a valid temporary security code.

In some instances, the credit providing entity manages credit transactions according to various standards and rules. For example, the payment card industry (PCI) rules prohibit giving a temporary card to a customer that is tied to a user's primary account number (PAN). Additionally, any virtual card needs to have a valid account number, a valid expiration date and a valid security code so that transactions can be completed on a merchant credit card machine.

To conform to the PCI rules, embodiments generate a virtual co-branded credit card number for a qualified customer that is not tied to the customer's PAN. The virtual co-branded credit card number also has a valid temporary virtual account number (VAN) that is not tied to the customer's PAN, a valid temporary expiration date and a valid temporary security code so that it works with conventional payment processing systems.

The virtual co-branded credit card number enables a user to apply at the time of purchase for a credit card and then actually complete a purchase using the newly obtained credit line. Embodiments of the virtual co-branded credit card can be used as a temporary credit facility until a physical credit card can be sent to the customer or until a primary account number can be given to the customer.

In an embodiment, apply and buy co-branded virtual card system 100 includes customer credit qualification module 110 and customer virtual co-branded card access module 120. In general, apply and buy co-branded virtual card system 100 receives a customer application 105 for a co-branded card. Customer credit qualification module 110 will access credit database 115 to determine if the customer qualifies for the co-branded card. In one embodiment, various modules shown in FIG. 2 communicate over a cloud 111 infrastructure. An example of cloud 111 is a network such as the Internet or the like.

If the customer qualifies, customer credit qualification module 110 provides the qualification information to customer virtual co-branded card access module 120. Customer virtual co-branded card access module 120 will then add the customer information to the virtual co-branded card database 125. The customer then has the option to utilize the virtual co-branded card to make a purchase 140. In an embodiment, the customer can use the virtual co-branded card to make a purchase 140 at the time of customer application 105.

In one embodiment, the customer may use a smart device to apply for the co-branded card. In addition, the customer may use the smart device to access the virtual co-branded card database 125 to make purchase 140. Examples of a smart device include, but are not limited to, a mobile phone, tablet, smart glasses, smart watch, and the like. In general, the smart device provides the customer application 105 and accesses virtual co-branded card database 125 via wireless connectivity such as 3G, 4G, WiFi, Bluetooth, and the like.

In an embodiment, for example in a brick and mortar store, a customer has selected one or more goods to purchase. The customer takes the goods to a checkout register to perform the purchase process. At the register during the purchase, the customer is offered, or accesses an offer for, a virtual co-branded card. For example, the offer for the virtual co-branded card comes from the retail associate operating the register. By answering a few questions, the customer applies for the co-branded card and immediately is provided access to a virtual co-branded credit card number that can be used immediately for purchases. In one embodiment, immediate promotional offers may be presented to the customer upon issuance of the card to promote usage.

In another embodiment, the offer for the virtual co-branded card may be on a poster, flyer, business card or the like at the point of sale. In one embodiment, the poster includes a barcode, web address or the like. In this case, the customer applies for the co-branded card by scanning the barcode with a smart device. The scanning of the barcode will push the smart device to the co-branded card application website. By answering a few questions, the customer applies for the virtual co-branded card. In one embodiment, immediate promotional offers may be presented to the customer upon issuance of the card to promote usage. For example, in one embodiment, an electronic coupon may be issued to promote usage on the day of issuance.

In one embodiment, when customer credit qualification module 110 receives customer application 105, customer credit qualification module 110 acts in real-time to qualify the customer for the virtual co-branded card. In other words, the qualification process is performed in a few minutes or less.

In one embodiment, part of the qualifying process includes providing a credit available amount. For example, customer credit qualification module 110 may return a virtual co-branded card number with an available credit line of 500.00 USD. Although 500.00 USD is discussed herein, the amount of available credit may be another value.

In one embodiment, the initially available credit line may be a constant predetermined amount for every customer or the initially available credit line may be variable and based on customer credit history, credit score, and the like.

After the customer is qualified, customer credit qualification module 110 provides the qualification information to customer virtual co-branded card access module 120. Customer virtual co-branded card access module 120 then adds the customer virtual co-branded card number to virtual co-branded card number database 125. In addition, customer virtual co-branded card access module 120 provides the customer with at least one method for accessing the virtual co-branded card number.

For example, a method for accessing the virtual co-branded card number may include providing an app for the customer's smart device, providing a web address for the customer to login to the virtual co-branded card, providing a virtual co-branded card that can be displayed on the customer's smart device, and the like. In one embodiment, a store associate may be able to view the virtual card number to make purchases, but the details of the card (account number, expiration date and security code) may be hidden from the customer. In one embodiment, immediate promotional offers may be presented to the customer upon issuance of the card to promote usage and these promotional offers may be customized for the particular customer and can be presented electronically directly to the customer via the customer's smart device.

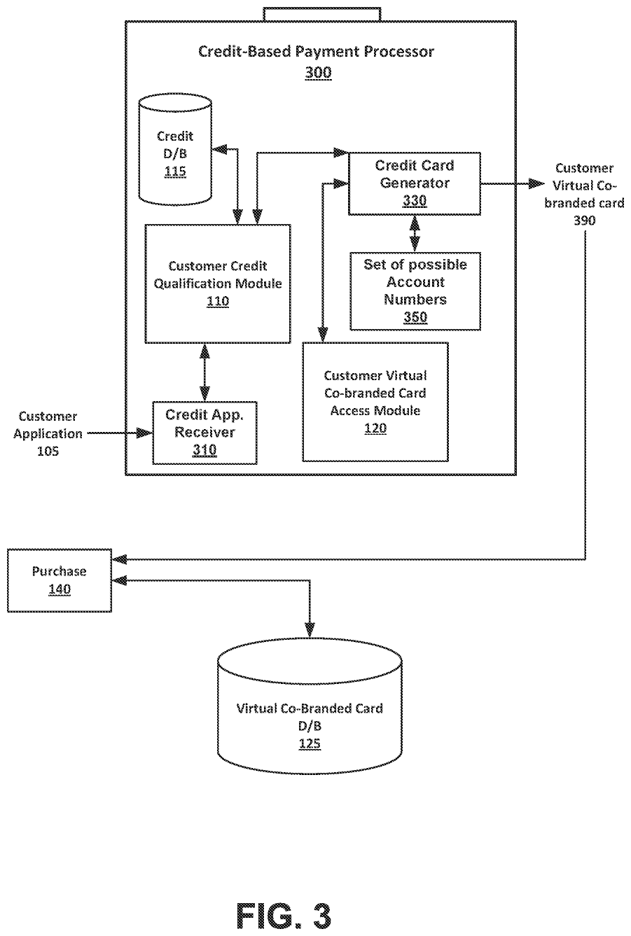

FIG. 3 is a block diagram of a credit-based payment processor 300 using a co-branded virtual card system, in accordance with an embodiment. System 300 of FIG. 3 is similar to system 100 of FIG. 2, but shows additional functionality such as a credit application receiver 310, a credit card generator, a possible set of account numbers 350 and a virtual co-branded credit card 390.

In one embodiment, the credit-based payment processor has a set of possible account numbers 350 from which every customer account is pulled from. The set of possible account numbers 350 is a set of numbers that conform to credit-based transaction rules and standards. In one embodiment, a sub-set of the set of possible account numbers is reserved for issuing virtual co-branded credit card numbers.

In one embodiment, a customer application is received at the credit application receiver 310. The credit application receiver communicates with the customer credit qualification module 110 and credit database 115 to qualify the customer application 105. Once the customer is qualified, a credit card generator 330 pulls a valid credit card number, valid expiration date and a valid security code from the set of possible account numbers 350 to generate a customer virtual co-branded card 390.

In one embodiment, the valid credit card number, valid expiration date and a valid security code of the customer virtual co-branded card 390 are not tied directly to the customer's Primary Account Number. Once issued, the virtual co-branded credit card 390 is managed by the customer virtual co-branded card access module 120. In one embodiment, the customer virtual co-branded card access module 120 may limit purchases on the customer virtual co-branded card 390 to a limit well below the customer's approved credit amount for fraud protection purposes. In another embodiment, the customer virtual co-branded card access module 120 may limit the number of purchases or set a very short expiration date for the customer virtual co-branded card 390. In one embodiment, the credit limit is increased after the physical credit card is issued.

In one embodiment, the customer virtual co-branded card 390 functions in conventional credit-based transactions as if it were tied to a user's primary account number. In one embodiment, step 140 includes presenting immediate promotional offers to the customer to promote usage after issuance.

In one embodiment, the virtual co-branded card conforms to a payment card industry (PCI) standard.

In one embodiment, the customer virtual co-branded card access module automatically prevents purchases using said virtual co-branded card after a predetermined period of time.

In one embodiment, the customer virtual co-branded card access module limits purchase amounts to a predetermined amount.

In one embodiment, the virtual co-branded card is reused for another new credit customer.

In one embodiment, the customer virtual co-branded card access module prevents the qualified customer for accessing the valid credit card number, the valid credit card expiration date and the valid credit card security code of the virtual co-branded card. In this embodiment, the details of the virtual co-branded card are not disclosed so that the virtual co-branded card can be reused.

FIG. 4 depicts a flow diagram for a method 400 for applying and buying with a co-branded virtual card, in accordance with an embodiment.

At 402, method 400 includes receiving a customer application for a co-branded credit card at a time of purchase. In one embodiment, the application is received electronically. In one embodiment, the application is entered manually by a sales associate. In one embodiment, the customer application for a co-branded credit card is received at a point of sale (POS). It is appreciated that the customer application may be received through any number of channels and may be received, for example, through a web page, a kiosk, at a merchant check-out, through a call center, via mail, through interactive voice response (IVR) or any other channel.

At 404, method 400 includes performing a customer qualification for the co-branded credit card at the time of purchase. In one embodiment, step 404 includes accessing credit report data associated with the applicant.

At 406, method 400 includes providing access to a virtual co-branded card number for a qualified customer, the virtual co-branded card number having an associated temporary valid credit card expiration date and a temporary valid credit card security code. In one embodiment, the virtual co-branded credit card information is sent directly to a retailer or directly back to the POS and is not directly provided to the customer.

At 408, method 400 includes authorizing the use of the virtual co-branded card to buy goods at the time of qualification. In one embodiment, 408 includes providing immediate promotional offers to the customer to promote usage.

In one embodiment, the virtual co-branded card is not associated with a primary account number tied to the qualified customer.

In one embodiment, the virtual co-branded card conforms to a payment card industry (PCI) standard.

In one embodiment, step 408 includes automatically preventing purchases using the virtual co-branded card after a predetermined period of time. In another embodiment, step 408 includes limiting purchase amounts to a predetermined amount.

In one embodiment, method 400 includes issuing a physical credit card associated with a primary account number of the qualified customer and in response to the issuance of the physical credit card, method 400 includes preventing access to said virtual co-branded card number. In one embodiment, method 400 includes preventing the qualified customer form accessing the valid credit card number, the valid temporary credit card expiration date and the valid temporary credit card security code of the virtual co-branded card number.

FIG. 5 depicts a flow diagram for a method 500 for applying and buying with a co-branded virtual card, in accordance with an embodiment.

At 502, method 500 includes qualifying a customer for a co-branded credit card number.

At 504, method 500 includes providing access to a virtual co-branded card number for the customer to use, the virtual co-branded card not associated with a primary account number associated with the customer and having a valid temporary credit card number, a valid temporary credit card expiration date and a valid temporary credit card security code.

At 506, method 500 includes processing a credit-based transaction using the virtual co-branded card number at the time of qualification.

At 508, method 500 includes authorizing the use of the virtual co-branded card number to buy goods at the time of qualification. In one embodiment, 508 includes providing immediate promotional offers to the customer to promote usage.

In one embodiment, method 500 includes selecting the valid credit card number from a plurality of possible account numbers. In one embodiment, a select group of possible account numbers is designated to be used as virtual co-branded credit cards.

In one embodiment, step 508 of method 500 includes allowing purchases using the virtual co-branded card number for a predetermined period of time.

In another embodiment, step 508 of method 500 includes limiting purchase transactions to a predetermined amount associated with the virtual credit card number.

In one embodiment, method 500 includes issuing a physical credit card associated with the primary account number of the customer and in response to the issuance of the physical card associated with the PAN, method 500 includes preventing access to said virtual co-branded card number.

In one embodiment, step 508 of method 500 includes preventing the customer form accessing the valid credit card number, the valid temporary credit card expiration date and the valid temporary credit card security code of the virtual co-branded card number.

FIG. 6 depicts a flow diagram for a method 600 for applying and buying with a co-branded virtual card number, in accordance with an embodiment.

At 602, method 600 includes determining a customer does not have a co-branded credit card number at a time of purchase.

At step 604, method 600 includes completing an application for the co-branded credit card at the time of purchase. In one embodiment, the credit application is performed over the telephone, over the Internet, on a paper form, on an electronic form and may be completed by a sales associate.

At step 606, method 600 receiving a customer qualification for the co-branded credit card at the time of purchase. Once approved for a line of credit, a temporary virtual co-branded credit card number is generated for the approved customer.

At step 608, method 600 includes providing access to a virtual co-branded card number for the customer, the virtual co-branded card number having a valid temporary credit card expiration date and a valid temporary credit card security code.

At step 610, method 600 includes authorizing the use of the virtual co-branded card number to buy goods at the time of qualification. In one embodiment, 610 includes providing immediate promotional offers to the customer upon issuance of the card to promote usage.

In one embodiment, step 608 of method 600 includes ensuring the virtual co-branded card number conforms to a payment card industry (PCI) standard.

In one embodiment, at step 608, method 600 includes automatically preventing purchases using the virtual co-branded card number after a predetermined period of time.

In one embodiment, at step 608, method 600 includes limiting purchase amounts to a predetermined amount.

In one embodiment, method 600 includes issuing a physical credit card associated with a primary account number of the qualified customer and preventing access to said virtual co-branded card number. In one embodiment, method 600 also includes reusing the virtual co-branded card number for another customer. In this embodiment, the same virtual account number may be used in conjunction with a newly created temporary expiration date and temporary security code.

In one embodiment, at step 608, method 600 includes preventing the qualified customer form accessing the valid credit card number, the valid credit card expiration date and the valid credit card security code of the virtual co-branded card.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. (canceled)

2. A computer-implemented method for generating a temporary co-branded virtual credit card and electronically transmitting the temporary co-branded virtual credit card to a recipient, the computer-implemented method comprising the steps of:
electronically receiving a customer request for a co-branded credit card from a point of sale location, said customer request indicating said point of sale location, and a store corresponding to said point of sale location;
performing a computer-generated customer qualification process to automatically determine if said customer qualifies for said co-branded credit card, said computer-generated customer qualification process occurring while a customer is at said point of sale location;
provided said customer qualifies for said co-branded credit card:
electronically accessing a memory containing payment card industry (PCI) information to obtain PCI rules defined by said point of sale location and said store as ascertained from said customer request; and
creating a computer-generated temporary co-branded virtual credit card for said customer, said temporary co-branded virtual credit card compliant with said PCI rules defined by said point of sale location and said store as ascertained from said customer request; and
electronically transmitting said computer-generated temporary co-branded virtual credit card to said recipient.

3. The computer-implemented method for generating a temporary co-branded virtual credit card of claim 2 wherein said creating said computer-generated temporary co-branded virtual credit card further comprises:
utilizing said PCI rules to create a computer-generated security code, wherein said computer-generated security code is compliant with said PCI rules.

4. The computer-implemented method for generating a temporary co-branded virtual credit card of claim 3 wherein said computer-generated security code cannot be accessed by said customer.

5. The computer-implemented method for generating a temporary co-branded virtual credit of claim 2 wherein said creating said computer-generated temporary co-branded virtual credit card further comprises:
utilizing said PCI rules to create a computer-generated expiration date of said temporary co-branded virtual credit, wherein said computer-generated expiration date of said temporary co-branded virtual credit is compliant with said PCI rules defined by said point of sale location and said store as ascertained from said customer request.

6. The computer-implemented method for generating a temporary co-branded virtual credit of claim 2 wherein said electronically transmitting said computer-generated temporary co-branded virtual credit card to said recipient further comprises:
electronically transmitting said computer-generated temporary co-branded virtual credit card to a merchant credit card machine at said point of sale location.

7. The computer-implemented method for generating a temporary co-branded virtual credit of claim 2 wherein said electronically transmitting said computer-generated temporary co-branded virtual credit card to said recipient further comprises:
electronically transmitting said computer-generated temporary co-branded virtual credit card to a mobile device of said customer.

8. The computer-implemented method for generating a temporary co-branded virtual credit of claim 2 wherein said computer-generated temporary co-branded virtual credit card is not associated with a primary account number associated with said customer.

9. The computer-implemented method for generating a temporary co-branded virtual credit card of claim 2 wherein a credit card number assigned to said temporary co-branded virtual credit card cannot be accessed by said customer.

10. The computer-implemented method for generating a temporary co-branded virtual credit card of claim 5 wherein said computer-generated expiration date of said temporary co-branded virtual credit cannot be accessed by said customer.

11. A computer-implemented method for generating a temporary co-branded virtual credit card and electronically transmitting the temporary co-branded virtual credit card to a recipient, the computer-implemented method comprising the steps of:
electronically receiving a customer request for a co-branded credit card from a point of sale location, said customer request indicating said point of sale location, and a store corresponding to said point of sale location;
performing a computer-generated customer qualification process to automatically determine if said customer qualifies for said co-branded credit card, said computer-generated customer qualification process occurring while a customer is at said point of sale location;
provided said customer qualifies for said co-branded credit card:
electronically accessing a memory containing payment card industry (PCI) information to obtain PCI rules defined by said point of sale location and said store as ascertained from said customer request;
creating a computer-generated temporary co-branded virtual credit card for said customer, said temporary co-branded virtual credit card compliant with said PCI rules defined by said point of sale location and said store as ascertained from said customer request; and
utilizing said PCI rules to create a computer-generated security code, wherein said computer-generated security code is compliant with said PCI rules; and
electronically transmitting said computer-generated temporary co-branded virtual credit card to said recipient.

12. The computer-implemented method for generating a temporary co-branded virtual credit card of claim 11 wherein said computer-generated security code cannot be accessed by said customer.

13. The computer-implemented method for generating a temporary co-branded virtual credit of claim 11 wherein said creating said computer-generated temporary co-branded virtual credit card further comprises:
utilizing said PCI rules to create a computer-generated expiration date of said temporary co-branded virtual credit, wherein said computer-generated expiration date of said temporary co-branded virtual credit is compliant with said PCI rules defined by said point of sale location and said store as ascertained from said customer request.

14. The computer-implemented method for generating a temporary co-branded virtual credit of claim 11 wherein said electronically transmitting said computer-generated temporary co-branded virtual credit card to said recipient further comprises:
electronically transmitting said computer-generated temporary co-branded virtual credit card to a merchant credit card machine at said point of sale location.

15. The computer-implemented method for generating a temporary co-branded virtual credit of claim 11 wherein said electronically transmitting said computer-generated temporary co-branded virtual credit card to said recipient further comprises:
electronically transmitting said computer-generated temporary co-branded virtual credit card to a mobile device of said customer.

16. The computer-implemented method for generating a temporary co-branded virtual credit of claim 11 wherein said computer-generated temporary co-branded virtual credit card is not associated with a primary account number associated with said customer.

17. The computer-implemented method for generating a temporary co-branded virtual credit card of claim 11 wherein a credit card number assigned to said temporary co-branded virtual credit card cannot be accessed by said customer.

18. The computer-implemented method for generating a temporary co-branded virtual credit card of claim 13 wherein said computer-generated expiration date of said temporary co-branded virtual credit cannot be accessed by said customer.

19. A computer-implemented method for generating a temporary co-branded virtual credit card and electronically transmitting the temporary co-branded virtual credit card to a recipient, the computer-implemented method comprising the steps of:
electronically receiving a customer request for a co-branded credit card from a point of sale location, said customer request indicating said point of sale location, and a store corresponding to said point of sale location;
performing a computer-generated customer qualification process to automatically determine if said customer qualifies for said co-branded credit card, said computer-generated customer qualification process occurring while a customer is at said point of sale location;
provided said customer qualifies for said co-branded credit card:
electronically accessing a memory containing payment card industry (PCI) information to obtain PCI rules defined by said point of sale location and said store as ascertained from said customer request;
creating a computer-generated temporary co-branded virtual credit card for said customer, said temporary co-branded virtual credit card compliant with said PCI rules defined by said point of sale location and said store as ascertained from said customer request;
utilizing said PCI rules to create a computer-generated security code, wherein said computer-generated security code is compliant with said PCI rules; and
utilizing said PCI rules to create a computer-generated expiration date of said temporary co-branded virtual credit, wherein said computer-generated expiration date of said temporary co-branded virtual credit is compliant with said PCI rules defined by said point of sale location and said store as ascertained from said customer request; and
electronically transmitting said computer-generated temporary co-branded virtual credit card to said recipient.

20. The computer-implemented method for generating a temporary co-branded virtual credit card of claim 19 wherein said customer cannot access a credit card number assigned to said temporary co-branded virtual credit card, said customer cannot access said computer-generated security code, and said customer cannot access said computer-generated expiration date of said temporary co-branded virtual credit.

21. The computer-implemented method for generating a temporary co-branded virtual credit of claim 19 wherein said computer-generated temporary co-branded virtual credit card is not associated with a primary account number associated with said customer.
